(19) United States
(12) Patent Application Publication
(10) Pub. No.: US 2010/0098515 A1
(43) Pub. Date: Apr. 22, 2010

(54) ATTACHMENT FASTENER

(75) Inventor: Antoine Raymond, Grenoble (FR)

Correspondence Address: BAKER & DANIELS LLP;111 E. WAYNE STREET, SUITE 800, FORT WAYNE, IN, 46802, US

(73) Assignee: A. RAYMOND ET CIE, Grenoble (FR)

(21) Appl. No.: 12/524,284

(22) PCT Filed: Feb. 14, 2008
(86) PCT No.: PCT/EP2008/001105

§ 371 Date: Jul. 23, 2009

(30) Foreign Application Priority Data
Mar. 16, 2007 (FR) 07/01939

(51) Int. Cl. F16B 21/06

(52) U.S. Cl. 411/500

(57) ABSTRACT

A fastening clip comprises: a body (1) made of a relatively rigid molded plastic material and provided with a head (2), a foot (3) and a flange (4) that is disposed at the junction between the head and the foot, and a sealing washer (5) made of a second, relatively flexible molded plastic material and fastened to the periphery of the flange. The washer is fastened to the flange by a cohesive chemical bond resulting from fusion between the first plastic material and the second plastic material during the molding process.

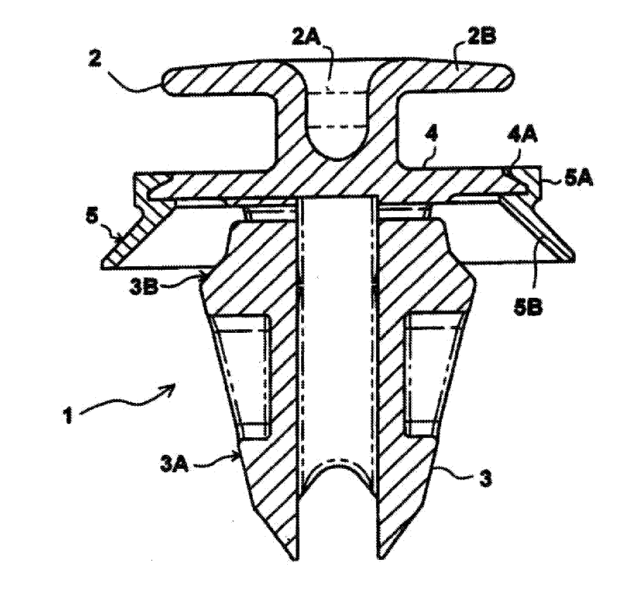

### CROSS-REFERENCE TO RELATED APPLICATION

This application is a U.S. National Phase Patent Application based on International Application Serial No. PCT/EP2008/001105 filed Feb. 14, 2008, the disclosure of which is hereby explicitly incorporated by reference herein.

### BACKGROUND OF THE INVENTION

1. Field of the Invention

The present invention relates to a fastening clip used to fasten elements to, for example, a land vehicle, particularly a land motor vehicle, and specifically to fasten a panel to a support such as a door of a land motor vehicle.

2. Description of the Related Art

A fastening clip of this kind is known from patent document FR-2673249, and includes a body made of relatively rigid molded plastic material and provided with a head adapted to be mounted to the panel through an orifice, a foot adapted to be mounted to the support through an orifice, and a flange that is disposed at the junction of the foot and the head, and a sealing washer made of relatively soft plastic material overmolded onto the periphery of the flange to ensure impermeability with respect to the support.

Patent document GB-2360322 describes a fastening clip similar to that described in the preceding document, but in which the overmolding is designed to keep the washer from escaping from the flange.

Finally, patent document EP-1025368 describes a clip with a plurality of flanges.

### SUMMARY OF THE INVENTION

The present invention provides a fastening clip in which the impermeability conferred by the washer of the fastening clip is further strengthened.

To this end, the invention is directed to a fastening clip including a body made of a first, relatively rigid molded plastic material and provided with a head, a foot and a flange that is disposed at the junction between the head and the foot, and a sealing washer made of a second, relatively flexible molded plastic material and fastened to the periphery of the flange, characterized in that the washer is fastened to the flange by a cohesive chemical bond resulting from fusion between the first plastic material and the second plastic material during the molding process.

The idea on which the invention is based is, therefore, to select two different but compatible plastic materials and to polymerize them during the molding process under such conditions as to cause cohesive bonding between the washer and the flange.

The clip according to the invention finds application in particular, but not exclusively, in fastening an element onto a support, for example a car door trim panel. The panel has a series of orifices in each of which a clip is mounted, and the panel is then held against the door or the support, which has a series of corresponding orifices into which the feet of the clips snap when the panel is pressed against the support. In the fastened position, the flange and the washer are clamped between the panel and the support, with the flange bearing against the panel and the washer against the support; the cooperation of the generally truncated-cone-shaped collar and the washer give the assemblage excellent impermeability.

The invention extends to a fastening clip whose head snaps on or employs a serrated strap, tape, etc., and is intended to secure electrical cables, conduit or other elements that are to be fastened to a support provided with an orifice.

In one form thereof, the present invention provides a fastening clip, including a body (1) made of a relatively rigid molded plastic material and provided with a head (2), a foot (3) and a flange (4) that is disposed at the junction between the head and the foot, and a sealing washer (5) made of a second, relatively flexible molded plastic material and fastened to the periphery of the flange, characterized in that the washer is fastened to the flange by a cohesive chemical bond resulting from fusion between the first plastic material and the second plastic material during the molding process.

### BRIEF DESCRIPTION OF THE DRAWING

The above mentioned and other features and objects of this invention, and the manner of attaining them, will become more apparent and the invention itself will be better understood by reference to the following description of an embodiment of the invention taken in conjunction with the accompanying drawing, wherein:

The sole FIGURE is a longitudinal sectional view of a fastening clip for fastening a panel to a support.

Corresponding reference characters indicate corresponding parts throughout the view. Although the exemplification set out herein illustrates an embodiment of the invention, the embodiment disclosed below is not intended to be exhaustive or to be construed as limiting the scope of the invention to the precise form disclosed.

### DETAILED DESCRIPTION

The sole FIGURE represents a fastening clip for fastening a panel to a support, comprising a body 1 made of a first, relatively rigid molded plastic material and provided with a head 2, a foot 3 and a flange 4 that is disposed at the junction between the head and the foot.

The head 2 has a central bore 2A bordered by an annular disk 2B serving as a stop to immobilize the head of the clip in a longitudinal direction.

The foot 3 is composed of an elastically deformable central core surrounded by a shank formed of two oppositely disposed, truncated-cone-shaped, elongate sections with a common base with one, 3A, forming the free end of the shank and having its tip oriented toward that end, and the other, 3B, having its tip oriented toward the head 2.

The flange 4 is in the form of an annular disk whose outer peripheral edge is provided with a chamfer. When the clip is mounted on the panel, this chamfer interposes itself between the disk 2B of the head and the flange 4.

The clip also comprises a sealing washer 5 made of a second molded plastic material that is relatively flexible, in other words much softer than the first plastic material of which the body of the clip is composed.

Washer 5 has an inner peripheral edge 5A that has an internal groove in which the chamfer on the outer edge of the flange 4 engages. It also has a truncated-cone-shaped peripheral lip 5B that projects from edge 5A on the side proximate the foot 3 and flares as it extends toward the foot 3.

According to the invention, the inner peripheral edge of the washer 5 is fastened to the outer peripheral edge of the flange by cohesive bonding during the molding of the clip. Consequently, the body 1, including head 2, foot 3 and flange 4 with washer 5, thus is fabricated in one piece by molding the two plastic materials of the body 1 and the washer 5, respectively.

These two plastic materials can be thermoplastic materials. They are chosen to be compatible so as to cause this cohesive bonding during the one-step injection molding of the body and the washer of the clip. The bonding can occur, for example, during the vulcanization phase of the raw materials (the molecules, once placed inside the production mold for the bimaterial clip, combine at given temperatures that promote good chemical adhesion).

By way of example, the following may, for example, be chosen as the pair of compatible plastic materials:
an acetal (POM) copolymer (such as Hostaform C9021, supplied by Ticona, or Kepital F20-30, supplied by Kep) with a TPE-S styrene copolymer (such as Thermolast K, supplied by Kraiburg)
a PA6/PP (such as Orgalloy RS6000, supplied by Arkema) with a TPE-S (such as Thermolast K or Vitaprene, supplied by VTP)
a PP (such as Exxtral CNU011, supplied by ExxonMobil) with a PP-EPDM (such as Santoprene, supplied by ExxonMobil) or an SEBS (such as Multiflex, supplied by Multibase)

The chemical cohesion (or chemical adhesion) thus is based on the formation of ionic-covalent chemical bonds. These bonds are among the strongest (on the order of 1000 kJ/mol), and ensure high breaking strength and better durability for the cemented assemblage, thereby reinforcing the impermeability conferred by the washer of the clip according to the invention.

While this invention has been described as having a preferred design, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

1-2. (canceled)

3. A fastening clip, comprising:
a body made of a relatively rigid molded plastic material, and including a head, a foot, and a flange disposed at a junction between said head and said foot; and
a sealing washer made of a second, relatively flexible molded plastic material and fastened to a periphery of said flange by a cohesive chemical bond resulting from fusion between said first plastic material and said second plastic material during molding of said first and second plastic materials.

4. The clip of claim 3, wherein said head is adapted to be mounted to a panel and said foot is adapted to be mounted to a support, said washer sealable against said support.
